(19) United States
(12) Patent Application Publication
(10) Pub. No.: US 2012/0284981 A1
(43) Pub. Date: Nov. 15, 2012

(54) MANUALLY GUIDED PRESS DEVICE

(76) Inventors: Martin Bungter, Monchengladbach (DE); Volker Reichel, Neuss (DE); Jörg Hanisch, Wuppertal (DE); Günther Odenthal, Monchengladbach (DE); Sven Meyer, Wermelskirchen (DE)

(21) Appl. No.: 13/509,164

(22) PCT Filed: Nov. 17, 2010
(86) PCT No.: PCT/EP2010/067641

§ 371 Date: Jul. 19, 2012

(30) Foreign Application Priority Data
Nov. 17, 2009 (DE) 20 2009 015 515.3

(51) Int. Cl. B25B 27/10

(52) U.S. Cl. 29/237

(57) ABSTRACT

A manual press device for connecting two work pieces by means of embossing, comprising a press tool, a converting device, and an electric motor. The electric motor is designed as a brushless electric motor, and preferably connected directly to a hydraulic pump without interconnecting a transmission.

### BACKGROUND

1. Field of the Disclosure

The disclosure refers to a manually guided press device for connecting two work pieces. In particular, the press device of the disclosure is suited for connecting a pipe with a press fitting by pressing. The disclosure further relates to manually guided press devices for pressing cable lugs.

2. Discussion of the Background Art

Such manually guided press devices comprise a pressing tool with a plurality of pressing jaws. With a pressing tool for pipe connections, the pressing jaws embrace the press fitting slipped over the pipe. By closing the pressing jaws the press fitting and the pipe are deformed or pressed. With pressing tools for cable lugs, the same are pressed by closing pressing jaws, the cable lug being positioned between at least two pressing jaws. In this case, one of the pressing jaws may be stationary. For the generation of the necessary high pressing forces, the pressing tool is connected to a converting device, typically an electrohydraulic or electromechanic converting device. The converting device is generally driven by an electric motor with the interposition of a transmission. A hydraulic converting device comprises a hydraulic pump, usually a piston pump or a gear pump. The pump is driven by a brush motor. Due to their construction, the pumps employed, which have to generate a high torque, require a rather low drive speed, typically about 2,000 to 5,000 rotations per minute. However, since the brush motor is operated at much higher speeds, a reduction gearing is arranged between the motor and the pump. With a hydraulic converting device, the hydraulic medium conveyed by the pump displaces a working piston. The working piston is connected with the pressing jaws so that high pressing forces can be transmitted to pressing jaws by the working piston. Upon reaching the set or predetermined maximum pressing force, the pressure chamber provided for the actuation of the working piston is opened by means of a valve, typically in the form of a needle valve, so that a sudden pressure reduction occurs in the pressure chamber. The pressure reduction causes an increase in the pump speed that is detected via a rotational speed sensor and causes an automatic deactivation of the electric motor. A return spring thereafter pushes back the working piston and the pressing jaws are thereby opened.

Such manually guided press devices have to be maintained at regular intervals. Studies have shown that the component determining the maintenance interval is the brush motor. Due to the frequent starting under load and to the provision of stop functions in which a short circuit is produced via the brush, the brushes of the brush motor are subjected to extensive wear.

It is an object of the disclosure to provide a manually guided press device for which longer maintenance intervals are realized.

### SUMMARY

The manually guided press device of the disclosure for connecting a pipe with a press fitting by pressing comprises a pressing tool with a plurality of pressing jaws. The pressing tool is driven by an electric motor with the interposition of a converting device. In particular, the converting device is an electrohydraulic or an electromechanic converting device. According to the disclosure the electric motor is a brushless motor. It is a significant advantage of a brushless electric motor over the brush motors used in the known pressing tools that no wearprone brushes are provided. The use of a brushless electric motor allows omitting the brushes that are subject to extensive wear due to high loads. Thereby, it becomes possible to extend the maintenance cycles significantly. Specifically, the number of pressing operations that can be performed between two maintenance checks can at least be doubled or even tripled.

Further, the use of a brushless electric motor, as contemplated by the disclosure, has the advantage that the maintenance costs are reduced, since no replacement of the brushes or the entire brush motor is required.

The electric motor is an external or internal rotor motor. Preferably, the electric motor is a brushless external rotor motor. Compared to brushless internal rotor motors, external rotor motors have the advantage that, for the same overall dimensions, they rotate slower and have a higher torque. For example, a sevenpole external rotor motor comprises a stator with twelve grooves, with every second groove being wound. As a consequence, the filed rotates by 60° when the phase changes. In this example, the bell or the external rotor surrounding the stator has fourteen magnets or seven pole pairs distributed over 360°. When changing the phase, the external rotor moves seven times slower than the field so that the outer rotor rotates by only 8.57° when the field rotates by 60°. Thereby, a lower rotational speed is realized for the outer rotor.

In a particularly preferred embodiment the brushless electric motor is directly connected with the converting device. In this preferred development of the present disclosure a reduction gearing, ultimately necessary when using brush motors, can be omitted. When an electrohydraulic converting device is used, it is therefore particularly preferred that the output shaft of the electric motor is connected directly with the hydraulic pump, i.e. with the drive shaft of the hydraulic pump. Due to the omission of the gearing, possible in this embodiment, costs can be reduced. In particular, the necessary structural space can be reduced significantly. It is a particular advantage of the use of a brushless motor, in which the reduction gearing is omitted or drastically simplified, that the efficiency can be improved significantly. Losses occur in particular due to the friction within the gearing, which losses can be reduced significantly by a drastic simplification or even a complete omission of the gearing. Omitting the gearing, which is possible when a brushless motor is used, allows an increase in efficiency of, in particular, more than 20% and, more preferred, more than 25%. This has the advantage that the operating time can be extended significantly if the same accumulator is used, or that, for the same operating time, a smaller and thus lighter accumulator can be used. Another advantage of simplifying or omitting the gearing is a significantly reduced generation of noise. Further, the vibrations occurring, as well as the heat generated are reduced.

Preferably, the output shaft of the electric motor is arranged such that it is coaxial with the drive shaft of the hydraulic pump. Thus, a simple connection of the shafts can be realized with a small structural space required.

The use of a brushless electric motor for operating the press device has a particular advantage in that a brushless electric motor or the control device of the brushless electric motor allows realizing additional functions in a simple manner.

In a particularly preferred embodiment of the disclosure, a control device connected with or integrated in the electric motor is used not only to control the rotational speed required to generate a desired torque or a desired pressing force, but also to determine the current rotational speed. For example, it is possible to conclude on the motor speed from the voltage induced into the windings. This allows a simple detection of the fact that the motor speed increases. A sudden increase in motor speed occurs when the pressure valve is opened, i.e. as soon as the required pressing force is reached. This rise in the rotational speed of the motor can be determined in a simple manner through the control device and can be used to deactivate the electric motor. The rotational speed sensor required in known press devices and ultimately necessary to determine the rise in rotational speed when the valve opens, can be omitted because of the use of a brushless electric motor as contemplated by the disclosure. This allows for a reduction of manufacturing costs. In particular, this has the advantage that a component important to the function of the press device is replaced by the control device and that significantly more reliable determination of the rotational speed is thereby achieved. The rotational speed sensor that might result in considerably damage to the press device can no longer occur.

In another preferred embodiment, the determination or calculation of the motor torque and/or the pressing force generated by the pressing jaws is done directly from the parameters of the brushless electric motor. Thereby, an automatic deactivation of the electric motor upon reaching the desired or set pressing force can be realized in a simple manner. In particular, it is possible to omit or at least drastically simplify the valve that opens the pressure chamber in conventional press devices. The valve, which in known press devices is opened when the pressing force is reached, can be simplified in this preferred embodiment at least such that it merely is an emergency valve that prevents damage to the press device upon a failure of the control device.

Another advantage of using a brushless electric motor, especially in combination with a control device already existing or connected with the electric motor, is that upon reaching the set pressing force or upon the occurrence of malfunctions the motor can be decelerated by corresponding control commands or by software. It is thereby possible to avoid the extensive wear occurring with brush motors when the motor is decelerated by the short circuit produced.

Still another advantage of using a brushless electric motor is that a sensor-less commutation is possible. Thus, it is no longer necessary to provide failure-prone rotational speed sensors to monitor the pressing force or to control operation.

In a preferred development of the press device a setting device is provided. Using the setting device, it is possible, for example, to enter pressing parameters in a simple manner via keys and a display. The same are transmitted to the control device of the electric motor so that a direct simple control of the electric motor and thus of the entire press device is possible. Depending on the configuration of the control device and the parameters determined by the control device, it is thus possible that the desired pressing force merely has to be entered via the setting device. An adaptation in the mechanics, by which, for example the pressure point at which the valve opens is varied, is not required. In this respect, the structure of the press device is significantly simplified. Further, mechanical components are omitted which, especially due to the great forces occurring, could be damaged or are at least more maintenance-intensive.

In a particularly preferred development of the disclosure the setting device allows, for example, entering the type of press device used. This is advantageous in that a manually guided press device can be provided in which the pressing tool is exchangeable. Thus, a troublesome adaptation of the press device to the pressing tool is no longer required. It is only necessary to enter an ID number of the pressing tool, for example. In a particularly preferred development the type of pressing tool is detected automatically by the press device. This may be done by means of an identification of the type of the pressing tool which is detected, in particular automatically, by control device. Thus, the user can change the pressing tool and does not have to pay attention to an adaptation of the corresponding pressing parameters. Thereby, it is avoided, for example, that the maximum allowed pressing force of a particular pressing tool is exceeded.

In another preferred embodiment of the disclosure a signal output device is connected with the control device of the brushless electric motor. By means of the signal output device the finishing of the pressing can be signaled in a simple manner. The occurrence of malfunctions or the requirement of maintenance can be signaled by the signal output device. The signal output device may be an acoustic and/or tactile (vibration) signal output device. The in particular acoustic signal output may in this case be realized directly by the control device. In addition, the signal output device may also have a display.

According to the disclosure, the manually guided press device in a preferred embodiment is operated such that the control device connected with the electric motor is used, as described above, to determine the rotational speed and/or the torque and/or other pressing parameters. In addition, the control device can also be used to control a signal output device.

### BRIEF DESCRIPTION OF THE DRAWINGS

The following is a detailed description of preferred embodiments with reference to the accompanying drawings.

In the Figures:

FIG. 1 is a schematic sectional view of an embodiment of a manually guided press device for connecting a pipe with a press fitting by pressing, in accordance with the disclosure, and

FIG. 2 is a schematic side elevational view of an embodiment of a manually guided press device for pressing cable lugs, in accordance with the disclosure.

### DETAILED DESCRIPTION OF THE PREFERRED EMBODIMENT

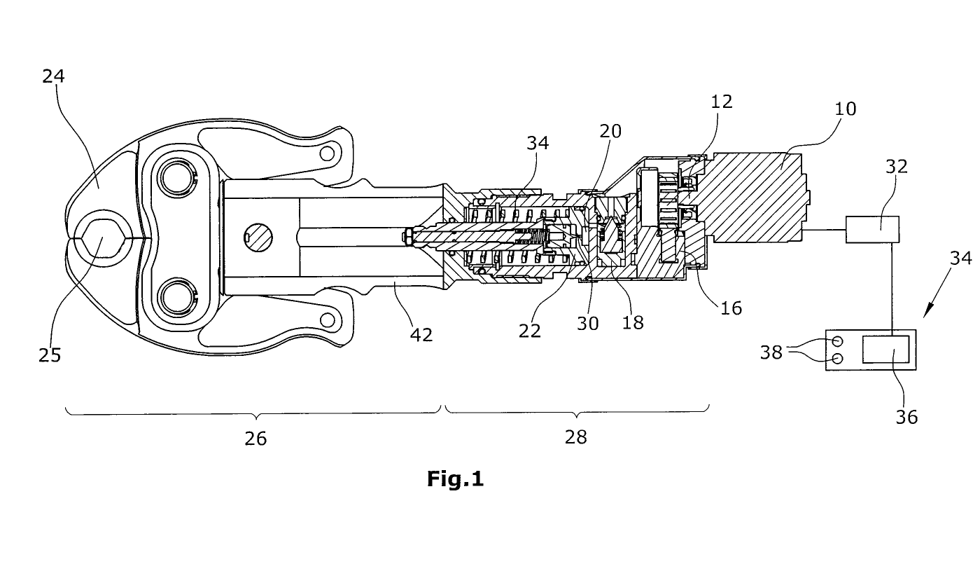

The manually guided press device for connecting pipes by pressing a press fitting (FIG. 1) comprises a brushless electric motor 10 whose output shaft 12 is connected with an eccentric 14. A pump piston 16 is driven via the eccentric 14. Further, for being supplied with power, the brushless electric motor 10 is connected to a non-illustrated rechargeable battery, such as an accumulator, or a power supply unit or the mains.

Hydraulic fluid is supplied to a chamber 20 via a control valve 18. By pumping the hydraulic fluid into the chamber 20, a working piston 22 is moved to the left in the drawing. The left end of the working piston 22 in the drawing is connected to the pressing jaws 24 of the pressing tool 26. By increasing the pressure in the chamber 20 and by a resulting displacement of the working piston 22 to the left, the pressing jaws 24 are closed. The pressing jaws 24 embrace the non-illustrated pipe as well as the press fitting surrounding the pipe, which are both situated in an opening 25.

The press device illustrated thus has three main components, i.e. the pressing tool 26, a converting device 28 and the electric motor 10.

In the embodiment illustrated a needle valve 30 is provided that opens the chamber 30 upon reaching the pressing force, so that the pressure in the chamber decreases abruptly. Due to this pressure reduction in the chamber 20 the rotational speed of the motor increases significantly. This increase in rotational speed is detected by a control device 32 connected to the brushless electric motor 10 and leads to a deactivation of the electric motor 10. As soon as the electric motor 10 is deactivated, a spring 34 pushes the working piston 22 back into its initial position illustrated in FIG. 1.

Further, the control device 32 may be connected to a setting device 34 that is in particular provided at the non-illustrated housing of the press device. Via the setting device 34, which may comprise a display 36 and input keys 38, it is possible to preset pump parameters, pressing forces etc. Further, the brushless electric motor provided by the disclosure can be used as a signal output device. This may be an acoustic signal output, a tactile signal output, such as the generation of vibrations, or an optical signal output via a display. Of course, the already existing display 36 of the setting device could be used for signal outputting purposes.

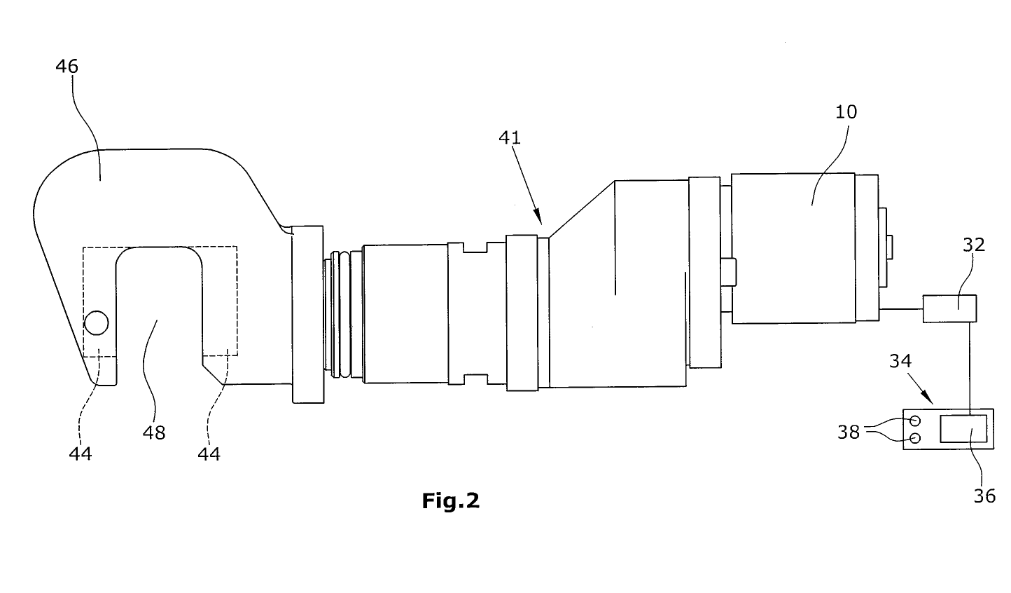

In another preferred embodiment of a press device, the press device is a press device for cable lugs (FIG. 2). The press device for cable lugs schematically illustrated in FIG. 2 is illustrated in non-sectional side elevation, the functioning corresponding to that of the pressing tool described with reference to FIG. 1. In particular, according to the disclosure, a brushless electric motor 10 is provided also in this case, which is also connected to an eccentric. Thus, the same components as illustrated in FIG. 1 are arranged in the housing 41. Only the generally cylindrical intermediate part 42 (FIG. 1) provided to receive the pressing jaws is omitted. Instead, pressing jaws 44 (FIG. 2) are connected to the working piston 22 (FIG. 1). The pressing jaws 44 are arranged within a pressing jaw head 46. The pressing jaw head 46 has an opening 48 into which the cable lug to be pressed is inserted.

For the rest, the structure of the pressing tool illustrated in FIG. 2 corresponds to the pressing tool described with reference to FIG. 1, in particular with respect to the design of the drive for the pressing jaws.

What is claimed is:

1. A manually guided press device for connecting two work pieces, in particular a pipe and a press fitting, by pressing, comprising
a pressing tool with a plurality of pressing jaws, and
a converting device connected to the pressing tool and driven by an electric motor, wherein
the electric motor is designed as a brushless electric motor.

2. The manually guided press device of claim 1, wherein the electric motor is designed as a brushless external rotor motor.

3. The manually guided press device of claim 1, wherein the electric motor is designed as a brushless internal rotor motor.

4. The manually guided press device of claim 1, wherein the electric motor is directly connected to the converting device, in particular to a hydraulic pump of the converting device.

5. The manually guided press device of claim 1, wherein the electric motor is connected to a control device that in particular serves to control the rotational speed.

6. The manually guided press device of claim 5, wherein a determination of the current rotational speed of the motor is made by means of the control device.

7. The manually guided press device of claim 5, wherein the control device is used to determine the rotational speed of the motor and/or the pressing force generated by the pressing jaws.

8. The manually guided press device of claim 4, further comprising a setting device for inputting press parameters, the setting device being connected to the control device.

9. The manually guided press device of claim 5, further comprising a signal output device connected to the control device.
